(19) United States
(12) Patent Application Publication
(10) Pub. No.: US 2006/0267716 A1
(43) Pub. Date: Nov. 30, 2006

(54) Inductor and base thereof

(75) Inventors: Yun Peng, Dongguan City (CN); Ching-Sung Kung, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/354,980

(22) Filed: Feb. 16, 2006

(30) Foreign Application Priority Data
May 27, 2005 (TW) 094117438

(51) Int. Cl. H01F 27/02

(52) U.S. Cl. 336/83

(57) ABSTRACT

An inductor includes a base and a cup core. The base, which is able to be adapted to be used with the cup core, includes a plurality of first embedding parts and a plurality of second embedding parts. The first embedding parts and the second embedding parts have different shapes and are disposed around the base by turns. The cup core has at lease two sidewalls connected to each other, and a protruding block is disposed in the corner between two adjacent sidewalls for allowing the second embedding parts of the base to be matched therewith. Besides, a recess is disposed on each sidewall for allowing the first embedding parts of the base to be matched therewith.

### CROSS REFERENCE TO RELATED APPLICATIONS

This non-provisional application claims priority under U.S.C. §119(a) on patent application no(s). 094117438, filed in Taiwan, Republic of China on May 27, 2005, the entire contents of which are hereby incorporated by reference.

### BACKGROUND OF THE INVENTION

1. Field of Invention

The invention relates to an inductor and a base thereof and, in particular to an inductor, of which the base and the cup core are well matched.

2. Related Art

Generally speaking, an inductor has the coil with a pin-shaped terminal, so that it cannot be made as a surface mounting device (SMD) and has to rely on a base with multiple flat and long pins to form as an SMD. With reference to FIGS. 1 and 2, the conventional inductor 1 has a core 11, a coil 12, a base 13, and a cup core 14. The coil 12 is wound around the core 11. The base 13 is roughly in an octagonal shape with eight sides 131, four of which are provided with four pins 132 for allowing the terminals of the coil 12 to be wound thereon. The base 13 is connected to one end of the core 11. The cup core 14 has four sidewalls 141 connected with each other so as to form an accommodation space 142 therebetween. The core 11 and the coil 12 are disposed within the accommodation space 142.

With reference to FIGS. 1, 3A, and 3B, each sidewall 141 of the cup core 14 has a recess 143. The core 11 and the coil 12 are disposed in the cup core 14, and then the base 13 is embedded in the cup core 14. However, since each side 131 of the base 13 touches against the recess 143 of the cup core 14, the base 13 cannot be combined with the cup core 14 tightly and stably. In this case, the core 11 and the coil 12 are partially exposed, resulting in some magnetic leakage. As the results, the electromagnetic interface (EMI) index of the inductor 1 increases.

Since the base 13 and the cup core 14 do not have a good match for positioning, a relative shift is formed between the base 13 and the cup core 14. Thus, the core 11 and the coil 12 are likely to move from their predetermined positions within the accommodation space 142 of the cup core 14 (as indicated by the dashed lines in FIG. 3B). Consequently, the stability of the inductance and current of the inductor 1 is affected, resulting in a higher error rate in production.

Therefore, during the assembling processes, more time is required to accurately align the relative positions of the base 13 and the cup core 14 in order to render good electrical properties. This does not only bring the production more difficulties, but also causes more time and costs. It is thus an important subject of the invention to provide a new inductor structure for a higher production yield and quality.

### SUMMARY OF THE INVENTION

In view of the foregoing, the invention is to provide an inductor and a base thereof with the advantage for aligning and positioning the base and the cup core so as to increase the production yield and quality of inductors.

To achieve the above, an inductor base of the invention is adapted to be used with a core, a coil, and a cup core for constructing an inductor. The inductor base includes a plurality of first embedding parts disposed around the inductor base; and a plurality of second embedding parts disposed around the inductor base. The first embedding parts and the second embedding parts are alternately disposed and the shapes of the first embedding parts are different from the shapes of the second embedding parts.

In addition, the invention also provides an inductor, which includes a core, a coil, a base and a cup core. The coil is wound around the core. The base is coupled to one end of the core and has a plurality of first embedding parts and a plurality of second embedding parts alternately disposed around the base. The shapes of the first embedding parts are different from those of the second embedding parts. The cup core has at lease two sidewalls connected to each other, and a protruding block is disposed in the corner between two adjacent sidewalls for allowing the second embedding parts of the base to be matched therewith. Besides, a recess is disposed on each sidewall for allowing the first embedding parts of the base to be matched therewith.

As mentioned above, the configurations of the first embedding parts and the second embedding parts make the base and the cup core to be well positioned. Such a structure avoids relative motion of the base and the cup core that may result in bad inductor quality. Besides, the structure of the inductor and its base can reduce the height of the inductor. The cup core can completely cover around the core and the coil to avoid their exposure to the environment, which prevents magnetic leakage and increases the electromagnetic shielding. Consequently, the EMI and GAP values of the inductor can be reduced whereas the Cpk value (Process Capability index related to both dispersion and centeredness) is increased. In comparing with the prior art, the invention has the advantages of easy operations, less work time, and higher production yield and quality.

### BRIEF DESCRIPTION OF THE DRAWINGS

The invention will become more fully understood from the detailed description given herein below illustration only; and thus is not limitative of the present invention, and wherein:

FIG. 1 is a three-dimensional exploded view of the conventional inductor,

FIG. 2 is a schematic view of the base of the conventional inductor in FIG. 1;

FIG. 3A is a side view of the conventional inductor in FIG. 1;

FIG. 3B is a top view of the conventional inductor in FIG. 1;

FIG. 4 is a three-dimensional exploded view of an inductor according to a preferred embodiment of the invention;

FIG. 5A is a schematic view of an inductor base of the inductor in FIG. 4;

FIG. 5B is a schematic view of a cup core of the inductor in FIG. 4;

FIG. 6 is a top view of the assembled inductor in FIG. 4; and

FIG. 7 is a side view of the inductor in FIG. 4.

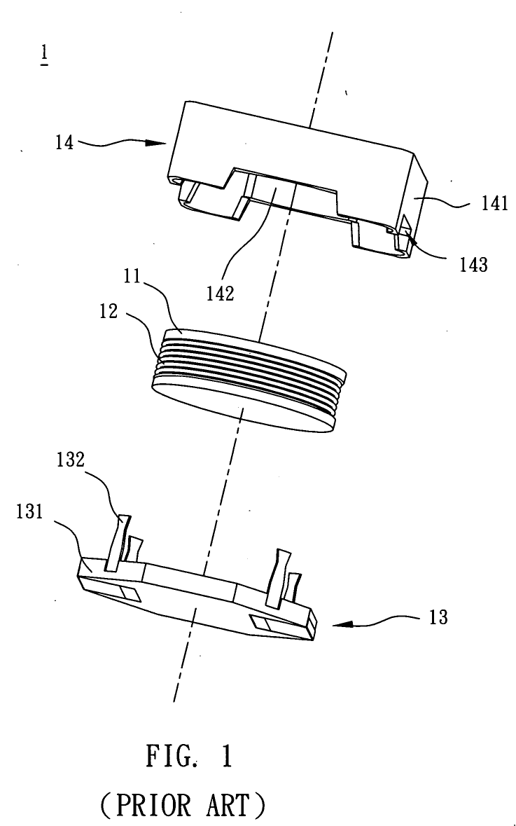

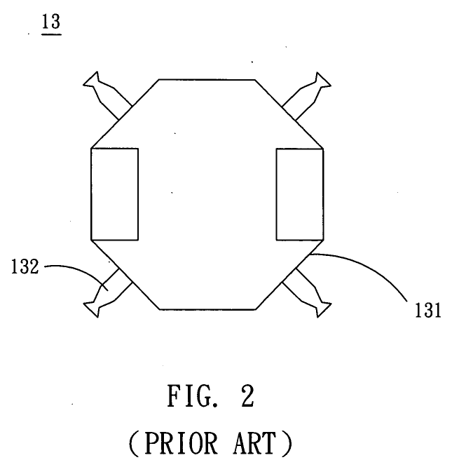

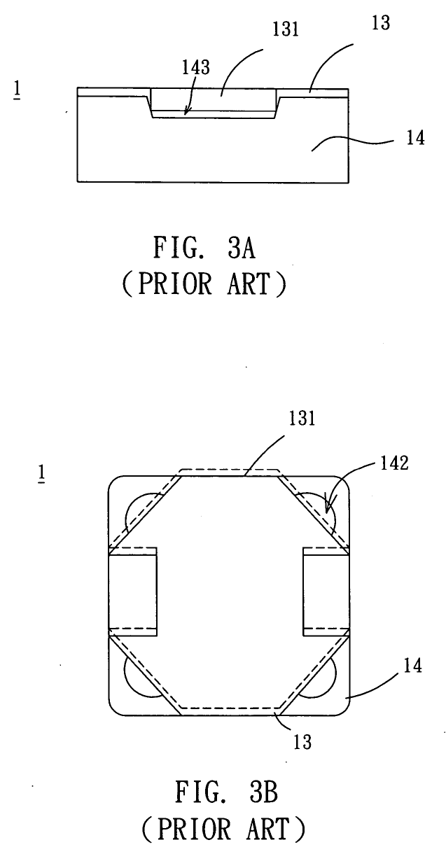

### DETAILED DESCRIPTION OF THE INVENTION

The present invention will be apparent from the following detailed description, which proceeds with reference to the accompanying drawings, wherein the same references relate to the same elements.

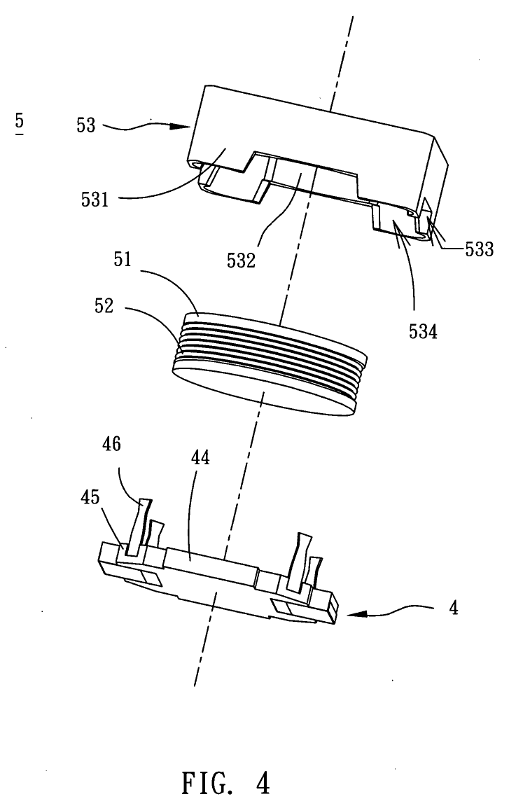

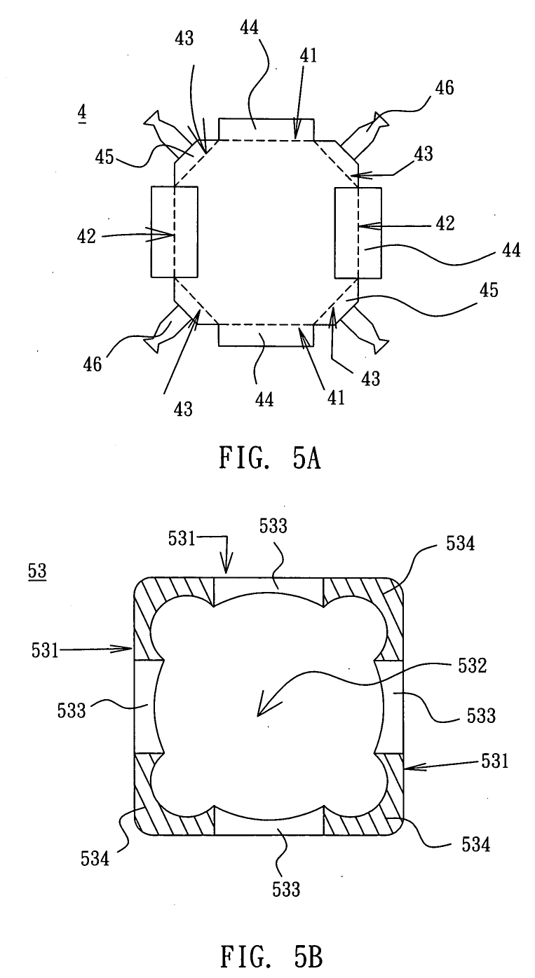

With reference to FIGS. 4 and 5A, an inductor 5 according to a preferred embodiment of the invention includes a core 51, a coil 52, a cup core 53, and a base 4. The core 51 is made of a drum-shaped magnetic material, and the coil 52 is wound around the core 51. The base 4 is coupled to one end of the core 51. The pins 46 of the base 4 are bent toward the core 51, so that the terminals of the coil 52 can be wound at the pins 46.

As shown in FIG. 5A, the base 4 is roughly in an octagonal shape, and has two opposite horizontal sides 41, two opposite vertical sides 42, and four slant sides 43 (indicated by dashed lines). The four slant sides 43 separately connect the horizontal sides 41 and the vertical sides 42. Several first embedding parts 44 and several second embedding parts 45 are provided around the base 4, and the shapes of the first embedding parts 44 are different from the shapes of the second embedding parts 45. Each of the first embedding parts 44 locates at each of the horizontal sides 41 or vertical sides 42, and each of the second embedding parts 45 locates at each of the slant sides 43. The first embedding parts 44 and the second embedding 45 are disposed by turn around the base 4. Each of the first embedding parts 44 has a rectangular shape, and each of the second embedding parts 45 has a trapezoidal shape. In addition, there is a pin 46 penetrating from each of the second embedding parts 45 so as to allow the terminals of the coil 52 to be connected therewith. Therefore, not only the base 4 provides the carrier function of supporting the core 51 and the coil 52, but also the inductor 5 can electrically connect to an external PCB circuit via the pins 46.

With reference to FIGS. 4 and 5B, the cup core 53 is a standard cup core commonly seen on the market. It has a roughly square shape with four sidewalls 531 that are connected to each other so as to form an accommodation space 532 therebetween for allowing the core 51 and the coil 52 to be disposed therein.

A protruding block 534 is formed at the corner of every two sidewalls 531, and each sidewall 531 is provided with a recess 533, such as a rectangular recess. When the core 51 and the coil 52 are disposed in the accommodation space 532 of the cup core 53, and then the base 4 and the cup core 53 are combined. When the base 4 is disposed in the cup core 53, each of the first embedding parts 44 of the base 4 respectively matches with the corresponding recess 533 of the cup core 53, and each of the second embedding parts 45 of the base 4 respectively matches with the relative protruding blocks 534 of the cup core 53.

By using the structure of the first embedding parts 44 and the second embedding parts 45, the inductor can be well assembled because of the perfect match between the cup core and the embedding parts. Accordingly, the base 4 and the cup core can be positioned more easily.

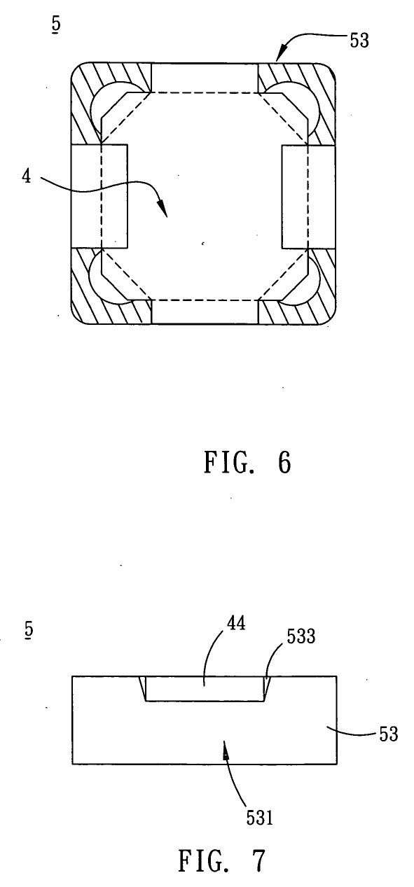

Please refer to FIGS. 5A, 5B, and 6. During the assembling process of the inductor 5, the location of each of the recesses 533 of the cup core 53 is respective to that of each of the first embedding parts 44 of the base 4, whereby enabling users to assemble the cup core 53 and the base 4 more easily. Therefore, Regarding to the assembling process of inductor 5, the steps are simplified and the operations are easier. As the results, the invention can reduce the work time and production cost. Moreover, the second embedding parts 45 of the base 4 are positioned in and touching against the concave parts constructed between the protruding blocks 534, so that the base 4 is hard to move relative to the cup core 53. This kind of structure thus achieves a stable effect, so that the inductance and saturation current of the inductor stably increase. This will result in a higher Cpk (Process Capability index related to both dispersion and centeredness) value.

With reference to FIGS. 4 and 7, since the base 4 and the cup core 53 have a good match, the GAP value of the core 51 and the cup core 53 close to the base 4 can be reduced. In comparison with the conventional inductor structure, the design of the invention can make the cup core 53 completely cover around the core 51 and the coil 52. The core 51 and the coil 52 are thus not exposed so as to avoid the problem of magnetic leakage. In contrast, the electromagnetic shielding is increased, and the EMI of the inductor 5 is reduced. Besides, the first embedding parts 44 of the base 4 are embedded into the recesses 533 of the cup core 53, whereby rendering a smaller height for the inductor 5. The stability of the inductor 5 also increases, which is of great industrial values.

In summary, the configurations of the first embedding parts and the second embedding parts make the base and the cup core to be well positioned. Such a structure avoids relative shift of the base and the cup core that may result in bad inductor quality. Also, the matched structure of the inductor and its base can reduce the height of the inductor. Further, the cup core can completely cover around the core and the coil to avoid their exposure to the environment, which prevents magnetic leakage and increases the electromagnetic shielding. Consequently, the EMI and GAP values of the inductor can be reduced whereas the Cpk (Process Capability index related to both dispersion and centeredness) value is increased. In comparing with the prior art, the invention has the advantages of easy operations, less work time, and higher production yield and quality.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An inductor base adapted to be used with a cup core, comprising:
a plurality of first embedding parts disposed around the base; and
a plurality of second embedding parts disposed around the base, wherein each of the first embedding parts and each of the second embedding parts are alternately disposed and shapes of the first embedding parts are different from those of the second embedding parts.

2. The inductor base of claim 1, wherein the cup core has at least two sidewalls connected to each other, a protruding block formed at a corner between each two adjacent sidewalls for allowing the second embedding parts of the inductor base to be matched therewith, and a recess formed on each of the sidewalls for allowing the first embedding parts of the inductor base to be matched therewith.

3. The inductor base of claim 2, wherein a shape of each of the first embedding parts corresponds to that of the corresponding recess.

4. The inductor base of claim 2, wherein each of the recesses is a rectangular concave space.

5. The inductor base of claim 1, wherein the inductor base has an octagonal shape with two opposite horizontal sides, two opposite vertical sides, and four slant sides connecting the horizontal sides and the vertical sides.

6. The inductor base of claim 5, wherein the first embedding parts are disposed at the horizontal sides and the vertical sides, respectively and the second embedding parts are disposed at the slant sides, respectively.

7. The inductor base of claim 1, wherein each of the first embedding parts has a rectangular shape and each of the second embedding parts has a trapezoidal shape.

8. The inductor base of claim 1, further comprising:
a plurality of pins located at the second embedding parts.

9. An inductor, comprising:
a base, which includes a plurality of first embedding parts and a plurality of second embedding parts disposed by turns, wherein a shape of each of the first embedding parts are different from that of each of the second embedding parts; and
a cup core having at least two sidewalls connected to each other, wherein a protruding block is disposed at a corner between each two adjacent sidewalls for allowing the second embedding parts of the base to be matched therewith and a recess is formed on each of the sidewalls for allowing the first embedding parts of the base to be matched therewith.

10. The inductor of claim 9, further comprising a core and a coil wound around the core, wherein the cup core has four sidewalls connected to each other so as to form an accommodation space for allowing the core and the coil to be disposed therein.

11. The inductor of claim 9, wherein the base has an octagonal shape with two opposite horizontal sides, two opposite vertical sides, and four slant sides connecting the horizontal sides and the vertical sides.

12. The inductor of claim 11, wherein the first embedding parts are disposed at the horizontal sides and the vertical sides, respectively and the second embedding parts are disposed at the slant sides, respectively.

13. The inductor of claim 9, wherein the base further comprises a plurality of pins located at the second embedding parts for connecting with terminals of the coil.

14. The inductor of claim 9, wherein a shape of each of the first embedding parts corresponds to that of the corresponding recess.

15. The inductor of claim 9, wherein each of the first embedding parts has a rectangular shape and each of the second embedding parts has a trapezoidal shape.

16. The inductor of claim 9, wherein each of the recesses is a rectangular concave space.
